(19) United States
(12) Patent Application Publication
(10) Pub. No.: US 2026/0277221 A1
(43) Pub. Date: Sep. 17, 2026

(54) REACTION WHEEL SYSTEMS FOR FALL DIRECTION CONTROL IN DYNAMICALLY STABLE ROBOTS AND RELATED TECHNOLOGY

(71) Applicant: Agility Robotics, Inc., Pittsburgh, PA (US)

(72) Inventors: Anish Mampetta, Sunnyvale, CA (US); Andrew Abate, Corvallis, OR (US)

(21) Appl. No.: 19/566,392

(22) Filed: Mar. 13, 2026

Related U.S. Application Data
(60) Provisional application No. 63/772,472, filed on Mar. 15, 2025.
(60) Provisional application No. 63/811,394, filed on May 23, 2025.
(60) Provisional application No. 63/855,186, filed on Jul. 31, 2025.
(60) Provisional application No. 63/947,952, filed on Dec. 23, 2025.

(51) Int. Cl. G05D 1/49; B62D 57/028; G05D 1/622; G05D 109/12

(52) U.S. Cl. CPC G05D 1/49; B62D 57/028; G05D 1/622; G05D 2109/12

(57) ABSTRACT

A robot system is provided herein. The robot system includes a locomotion base configured to support the robot system and a torso carried by the locomotion base. The robot system further includes at least one reaction wheel mounted within the torso. The robot system further includes a sensor suite configured to detect environmental conditions including at least one of a presence of one or more humans, obstacles, or safe zones. The robot system further includes a safety controller configured to monitor the environmental conditions detected by the sensor suite, determine a safe fall direction based on the environmental conditions, detect a fault condition, and upon detecting the fault condition, actuate the at least one reaction wheel to generate a biasing torque that influences a fall trajectory of the robot system toward the safe fall direction.

### CROSS-REFERENCE TO RELATED APPLICATION

This claims the benefit of 1) U.S. Provisional Application No. 63/772,472, filed Mar. 15, 2025; 2) U.S. Provisional Application No. 63/811,394, filed May 23, 2025; 3) U.S. Provisional Application No. 63/855,186, filed Jul. 31, 2025; and 4) U.S. Provisional Application No. 63/947,952, filed Dec. 23, 2025. The foregoing applications are incorporated herein by reference in their entirety. To the extent the foregoing applications or any other material incorporated by reference conflicts with the present disclosure, the present disclosure controls.

### FIELD

The present technology relates to dynamically stable robots.

### BACKGROUND

Modern robotics has emerged as a transformative technology with the potential to revolutionize numerous aspects of industrial operations, manufacturing processes, and service delivery across diverse sectors. Contemporary robot systems integrate sophisticated mechanical engineering, computational intelligence, and sensor technologies to create autonomous platforms capable of performing complex tasks that traditionally required human intervention. Advances in artificial intelligence, machine learning, and computer vision have enabled robot systems to adapt to dynamic environments, recognize patterns, and make decisions based on real-time sensory input. The convergence of these and other technological capabilities has created new opportunities for automation in a wide range of applications. The economic drivers supporting robot adoption include the potential for enhanced operational consistency, reduced labor costs, improved safety outcomes, and the ability to operate continuously without the limitations associated with human work schedules. Demographic trends in many developed nations, including aging populations and workforce shortages in certain sectors, have created additional incentives for organizations to explore robot-based solutions. The expanding capabilities of modern robot systems, combined with decreasing costs of implementation and maintenance, suggest that robot automation may become increasingly prevalent across a wide range of industrial and commercial applications in the coming decades.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a robot system is provided. The robot system includes a locomotion base configured to support the robot system. The robot system further includes a torso carried by the locomotion base. The robot system further includes at least one reaction wheel mounted within the torso. The robot system further includes a sensor suite configured to detect environmental conditions including at least one of a presence of one or more humans, obstacles, or safe zones. The robot system further includes a safety controller configured to monitor the environmental conditions detected by the sensor suite, determine a safe fall direction based on the environmental conditions, detect a fault condition, and, upon detecting the fault condition, actuate the at least one reaction wheel to generate a biasing torque that influences a fall trajectory of the robot system toward the safe fall direction.

According to other aspects of the present disclosure, the robot system may include one or more of the following features. The locomotion base may comprise a wheeled mobile base including two drive wheels. The two drive wheels may be coaxially arranged. The robot system may further comprise a leg connecting the wheeled mobile base to the torso. The leg may comprise a telescoping joint configured to adjust a height of the torso relative to the wheeled mobile base. The safety controller may be configured to retract the telescoping joint upon detecting the fault condition to lower a center of gravity of the robot system. The locomotion base may comprise a legged base including at least two legs configured to support and locomote the robot system. The legged base may comprise a bipedal humanoid configuration. At least one of the at least two legs may comprise a joint configured to adjust a height of the torso relative to a ground surface. The safety controller may be configured to actuate the joint to lower a center of gravity of the robot system upon detecting the fault condition. The at least one reaction wheel may comprise two reaction wheels positioned at an angle to each other within the torso. The safety controller may be configured to actuate the two reaction wheels in coordinated fashion to generate a net torque vector in the safe fall direction by combining outputs from the two reaction wheels in varying proportions. The at least one reaction wheel may comprise a single reaction wheel mounted on an actuated joint that allows a rotational axis of the single reaction wheel to be dynamically reoriented. The safety controller may be configured to command the actuated joint to orient the rotational axis of the single reaction wheel perpendicular to the safe fall direction and to actuate the single reaction wheel to generate the biasing torque. The safety controller may be further configured to preemptively determine the safe fall direction based on continuous environmental monitoring and store actuation parameters corresponding to the safe fall direction for retrieval upon detecting the fault condition. The safety controller may be configured to update the stored actuation parameters as the environmental conditions change. The fault condition may comprise at least one of a power loss, an instability detection indicating that the robot system has exceeded stability thresholds, or a human-proximity limit breach. The robot system may further comprise a capacitor-powered backup circuit configured to provide backup power to the safety controller and the at least one reaction wheel upon detection of a power loss. The capacitor-powered backup circuit may store sufficient energy to power actuation of the at least one reaction wheel for a duration of a fall-biasing response. The robot system may further comprise a joint-based directional damping system, wherein the safety controller is configured to coordinate actuation of the at least one reaction wheel with the joint-based directional damping system to provide enhanced fall direction control. The sensor suite may comprise a human detection system configured to identify a presence and location of one or more humans in proximity to the robot system, obstacle sensors configured to identify objects and structural features, and a mapping and localization system configured to identify designated safe zones within an environment. The safety controller may be configured to determine the safe fall direction by prioritizing directing falls away from detected humans and toward the designated safe zones. The torso may comprise a housing that encloses the at least one reaction wheel such that the at least one reaction wheel is not accessible from outside the housing.

According to another aspect of the present disclosure, a method for biasing a fall direction of a dynamically stable robot system during a safety event is provided. The method includes monitoring environmental conditions using a sensor suite configured to detect at least one of a presence of one or more humans, obstacles, or safe zones. The method further includes determining a safe fall direction based on the environmental conditions. The method further includes detecting a fault condition. The method further includes, upon detecting the fault condition, actuating at least one reaction wheel mounted within a torso of the robot system to generate a biasing torque that influences a fall trajectory of the robot system toward the safe fall direction.

According to other aspects of the present disclosure, the method may include one or more of the following features. The robot system may comprise a wheeled mobile base including two coaxially arranged drive wheels, and the method may further comprise retracting a telescoping leg connecting the wheeled mobile base to the torso upon detecting the fault condition to lower a center of gravity of the robot system. The robot system may comprise a legged base including at least two legs configured to support and locomote the robot system, and the method may further comprise actuating at least one joint of the at least two legs to lower a center of gravity of the robot system upon detecting the fault condition. The at least one reaction wheel may comprise two reaction wheels positioned at an angle to each other within the torso, and actuating the at least one reaction wheel may comprise actuating the two reaction wheels in coordinated fashion to generate a net torque vector in the safe fall direction by combining outputs from the two reaction wheels in varying proportions. The at least one reaction wheel may comprise a single reaction wheel mounted on an actuated joint, and actuating the at least one reaction wheel may comprise orienting a rotational axis of the single reaction wheel perpendicular to the safe fall direction by commanding the actuated joint and actuating the single reaction wheel to generate the biasing torque. The method may further comprise preemptively determining the safe fall direction based on continuous environmental monitoring prior to detecting the fault condition and storing actuation parameters corresponding to the safe fall direction. The method may further comprise updating the stored actuation parameters as the environmental conditions change. Actuating the at least one reaction wheel may comprise retrieving the stored actuation parameters upon detecting the fault condition and actuating the at least one reaction wheel according to the retrieved actuation parameters. Detecting the fault condition may comprise detecting at least one of a power loss, an instability detection indicating that the robot system has exceeded stability thresholds, or a human-proximity limit breach. Detecting the fault condition may comprise detecting a power loss, and the method may further comprise activating a capacitor-powered backup circuit to provide backup power for actuating the at least one reaction wheel. The method may further comprise coordinating actuation of the at least one reaction wheel with a joint-based directional damping system to provide enhanced fall direction control. Monitoring environmental conditions may comprise identifying a presence and location of one or more humans in proximity to the robot system using a human detection system. Monitoring environmental conditions may further comprise identifying objects and structural features using obstacle sensors. Monitoring environmental conditions may further comprise identifying designated safe zones within an environment using a mapping and localization system. Determining the safe fall direction may comprise prioritizing directing falls away from detected humans. Determining the safe fall direction may comprise prioritizing directing falls toward the designated safe zones. Determining the safe fall direction may comprise calculating actuation commands for the at least one reaction wheel based on the environmental conditions. The biasing torque may be generated by the at least one reaction wheel spinning within an enclosed housing of the torso such that the at least one reaction wheel is not accessible from outside the housing during the fall-biasing response. The robot system may be a dynamically stable wheeled robot, and the method may further comprise maintaining balance during normal operation using the at least one reaction wheel and generating the biasing torque using the at least one reaction wheel during the safety event. The method may further comprise counteracting destabilizing forces during movement of the robot system using the at least one reaction wheel, including counteracting forces encountered when rounding corners or traversing uneven terrain.

The foregoing general description of the illustrative embodiments and the following detailed description thereof are merely aspects of the teachings of this disclosure and are not restrictive.

### BRIEF DESCRIPTION OF FIGURES

Certain aspects of the present technology can be better understood with reference to the following drawings. The relative dimensions in the drawings may be to scale with respect to some embodiments of the present technology. With respect to other embodiments, the drawings may not be to scale. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIG. 1 is a system block diagram of a robot system in accordance with at least some embodiments of the present technology.

FIG. 2 is a node diagram of a sensor suite in accordance with at least some embodiments of the present technology.

FIG. 3 is a schematic top-down view illustrating determination of a safe fall direction for a robot in accordance with at least some embodiments of the present technology.

FIG. 4 is a node diagram of a legged robot system in accordance with at least some embodiments of the present technology.

FIG. 5 is a schematic view of a reorientable single-wheel configuration in accordance with at least some embodiments of the present technology.

FIG. 6 is a schematic diagram illustrating coordinated actuation of two reaction wheels in accordance with at least some embodiments of the present technology.

FIG. 7 is a system diagram of a power system in accordance with at least some embodiments of the present technology.

FIG. 8 is a system diagram illustrating safety controller logic in accordance with at least some embodiments of the present technology.

FIG. 9 is a flowchart illustrating a method for biasing a fall direction of a robot system in accordance with at least some embodiments of the present technology.

FIG. 10 is a system diagram of a fall direction control system in accordance with at least some embodiments of the present technology.

### DETAILED DESCRIPTION

The following description sets forth aspects of the present technology. It should be recognized, however, that such description is not intended as a limitation on the scope of the present technology. Rather, the description also encompasses alternatives, combinations, and modifications to those aspects described herein.

Dynamically stable robots, including wheeled balancing robots and bipedal humanoids, present distinct safety challenges that differ from those associated with statically stable robotic platforms. Unlike statically stable robots that can remain upright without active control, dynamically stable robots require continuous active control to maintain balance, relying on real-time sensor feedback and actuator commands to prevent falling. This continuous balancing requirement means that any interruption to the control system—whether from power loss, sensor failure, actuator malfunction, or software fault—can result in the robot losing balance and falling. The direction and manner of such a fall can have substantial implications for safety outcomes, particularly when the robot operates in environments where humans, sensitive equipment, or hazardous materials are present. A robot falling toward a human can cause injury, while a robot falling toward sensitive equipment can cause damage or trigger secondary hazards. Moreover, in domestic environments where children, elderly individuals, or pets may be present, the unpredictability of fall direction compounds the risk, as these individuals may be less able to move out of the way or may not recognize the danger in time to react.

One approach to managing fault-state behavior in dynamically stable robots involves joint-based directional damping, where differential resistance is applied to joint motion to bias the direction of a fall. Joint-based damping systems apply greater resistance to motion in certain directions than in others, thereby influencing the trajectory of a falling robot by making movement in some directions more difficult than movement in other directions. While joint-based directional damping can provide some control over fall direction, this approach is passive in nature. Passive damping systems resist motion but do not actively generate torque to push the robot in a desired direction. This limitation means that joint-based damping may be insufficient when the robot has substantial momentum in an undesired direction, as the damping may be limited to slowing or partially redirecting the fall rather than actively counteracting the momentum. Furthermore, joint-based damping systems may be compromised in scenarios where the joints themselves are the source of the fault condition, such as when a joint actuator fails or when a joint sensor provides erroneous data. In such cases, the damping system may be unable to function as intended, leaving the robot without effective fall direction control.

Alternative approaches that involve actively moving limbs to generate torque during a fall may introduce their own safety concerns. A robot that rapidly moves its arms or legs during a fall can create new collision hazards for nearby humans or objects, as the moving limbs sweep through space that may be occupied by people or equipment. The speed and force of limb movements during fall recovery or fall direction control can be substantial, and contact between a moving limb and a human can cause injury. This concern is particularly acute in domestic environments where the robot may be operating in close proximity to children who may be at a height where contact with moving robot limbs is more likely. Additionally, limb-based approaches depend on the limbs being in appropriate positions to generate the desired torque at the moment a fault is detected. If the limbs are extended, retracted, or otherwise positioned in a configuration that does not permit effective torque generation in the required direction, the fall direction control capability may be compromised.

Embodiments of the present technology address at least some of the foregoing and/or other challenges through the use of torso-mounted reaction wheels to actively influence the direction of a robot's fall when a fault or safety condition is detected. Upon detecting a safety event—such as power loss, instability, or breach of a human-proximity limit—the system actuates one or more reaction wheels mounted within the robot's torso to generate a biasing torque that influences the robot's fall trajectory toward a safer direction. This safer direction may be determined based on environmental sensing, such as directing the fall away from detected humans, away from sensitive equipment, toward structural features such as walls that may arrest the fall, or toward designated safe zones identified through mapping and localization systems. Unlike passive joint-based damping approaches that resist motion in certain directions, the reaction wheel approach actively generates torque to push the robot toward the desired fall direction, providing more forceful and rapid influence over the fall trajectory. Moreover, because the reaction wheels are contained within the robot's torso housing, the torque-generating mechanism does not extend into the space around the robot where humans might be present, meaning the fall-biasing action itself does not introduce new collision hazards from moving external components such as arms or legs.

The reaction wheel configurations for fall direction biasing can be understood as falling into at least two principal classes: fixed-axis multi-wheel systems and reorientable single-wheel systems. These classes represent different approaches to achieving directional control over the biasing torque, each with distinct trade-offs in mechanical arrangement, response characteristics, and design considerations. The first class encompasses fixed-axis multi-wheel configurations, where two or more reaction wheels are permanently mounted at defined orientations within the torso. In a representative form, two reaction wheels are positioned at an angle to each other, enabling torque generation in both the sagittal plane and the frontal plane. By combining the outputs from both wheels in varying proportions, the system can generate a net torque vector in the safe fall direction, providing full directional control over the fall trajectory without requiring mechanical reorientation of the wheel axes. This configuration offers faster response times since the wheels are already oriented and can begin generating torque immediately upon detection of a fault condition.

The second class comprises reorientable single-wheel configurations, where a single reaction wheel is mounted on an actuated joint that allows the wheel's rotational axis to be dynamically reoriented. This approach enables torque generation in any desired direction by adjusting the orientation of the reaction wheel prior to or during actuation, achieving directional flexibility through mechanical reorientation rather than through combining outputs from multiple fixed wheels. When a fault condition is detected, the system commands the actuated joint to orient the reaction wheel's rotational axis perpendicular to the desired fall direction, then actuates the reaction wheel to generate the biasing torque. The reorientable single-wheel configuration offers reduced weight and mechanical simplicity compared to multi-wheel configurations, as fewer reaction wheels and associated motors are present in the system. However, this configuration may require an additional actuation operation to orient the wheel axis before generating the biasing torque, which may introduce latency into the response. These two classes may be understood as complementary design philosophies: fixed-axis multi-wheel systems prioritize response speed, while reorientable single-wheel systems prioritize weight savings and mechanical simplicity at the cost of requiring the additional orientation operation.

In certain implementations, the robot may have a high aspect ratio with a tall body and a small base, similar to the aspect ratio of a human, enabling effective operation in environments designed for humans. A tall form factor allows the robot to interact with countertops, shelves, and other surfaces at heights that are convenient for human use, while a compact base allows the robot to navigate through doorways, hallways, and other spaces dimensioned for human passage. During normal operation, the reaction wheels may enable the robot to maintain static stability when the base is not moving and to reject external disturbances that might otherwise cause the robot to move in an undesired direction. For instance, if the robot is pushed forward from behind while stationary, a reaction wheel oriented in the sagittal plane can generate a counteracting torque to maintain balance without requiring the base to move forward. Similarly, a reaction wheel oriented in the frontal plane can counteract lateral disturbances, allowing the robot to remain stationary even when subjected to side forces. This capability is particularly beneficial in domestic settings where the robot may experience unplanned disturbances such as a wheel rolling over a threshold or an unintended push by a user, as the robot can maintain its position rather than producing an undesired motion that might pose a safety hazard.

Additionally, the reaction wheels may counteract short destabilizing forces such as those encountered when the robot rounds a corner or traverses uneven terrain during regular movement. When the robot turns, centripetal forces act on the robot's body, and the reaction wheels can generate torque to counteract these forces and maintain stability throughout the turn. In aggressive maneuvers, the robot may lean far enough to the side to take a turn on a single wheel, with the frontal reaction wheel providing the stabilizing torque. When traversing uneven terrain such as carpets, thresholds, or transitions between flooring types, the reaction wheels can respond to momentary disturbances faster than the drive wheels can reposition, smoothing the robot's motion and preventing the disturbances from propagating into larger instabilities. Thus, the reaction wheels may serve multiple functions during normal operation—maintaining static stability, rejecting external disturbances, and counteracting destabilizing forces during movement—in addition to the fall direction biasing function that is activated during safety events.

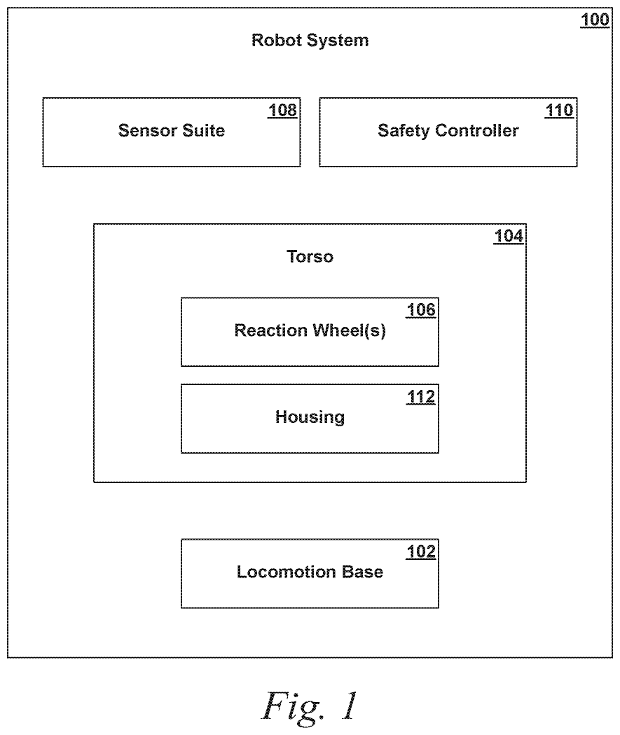

Referring to FIG. 1, a robot system 100 includes a locomotion base 102 configured to support the robot system 100, a torso 104 carried by the locomotion base 102, and at least one reaction wheel 106 mounted within the torso 104. The robot system 100 further includes a sensor suite 108 configured to detect environmental conditions and a safety controller 110 configured to monitor the environmental conditions detected by the sensor suite 108. The safety controller 110 can also be configured to determine a safe fall direction based on the environmental conditions, detect a fault condition, and, upon detecting the fault condition, actuate the at least one reaction wheel 106 to generate a biasing torque that influences a fall trajectory of the robot system 100 toward the safe fall direction. The torso 104 comprises a housing 112 that encloses the at least one reaction wheel 106 such that the at least one reaction wheel 106 is not accessible from outside the housing 112, thereby containing the torque-generating mechanism within the robot system 100 and preventing external contact with the spinning reaction wheel during operation or during a fall-biasing response. The sensor suite 108 may be configured to detect environmental conditions including at least one of a presence of one or more humans, obstacles, or safe zones, and the safety controller 110 receives data from the sensor suite 108 to inform the determination of the safe fall direction. In at least some implementations, the safety controller 110 may preemptively determine the safe fall direction based on continuous environmental monitoring and store actuation parameters corresponding to the safe fall direction for retrieval upon detecting the fault condition, as described in further detail below.

With continued reference to FIG. 1, the locomotion base 102 may comprise a wheeled mobile base including two drive wheels. The two drive wheels may be coaxially arranged, with the drive wheels placed close to each other such that the drive wheels are almost touching, thereby reducing the wheel base to a minimum. This compact wheel base configuration facilitates safe operation in a home environment by reducing the risk of the wheels running over the feet of a user or colliding with objects during turning. Furthermore, the compact configuration enables motion in tight corners including turn-at-point maneuvers that are beneficial for navigation in domestic spaces such as hallways, doorways, and rooms with furniture. The drive wheels may be actuated by motors located inside the respective wheels, forming hub motors or in-wheel motors that integrate the drive mechanism within the wheel structure itself. This in-wheel motor arrangement reduces the mechanical linkages between the motors and the wheels, simplifies the drivetrain, and allows the locomotion base 102 to maintain a compact form factor without external motor housings or transmission components extending beyond the wheel envelope.

The robot system 100 may further comprise a leg connecting the wheeled mobile base to the torso 104. In certain embodiments, the leg may comprise a telescoping joint configured to adjust a height of the torso 104 relative to the wheeled mobile base, with the telescoping joint including an upper part and a lower part that slide relative to each other along a telescoping axis. The torso 104 can be lowered along the telescoping axis of the leg to enable arms carried by the torso 104 to come down to ground level to pick objects from the floor, and the torso 104 can be raised to position the arms at heights suitable for interacting with countertops, shelves, tables, and other surfaces at elevations convenient for human use. Furthermore, the safety controller 110 may be configured to retract the telescoping joint upon detecting the fault condition to lower a center of gravity of the robot system 100, which reduces the potential energy available to accelerate the fall and facilitates the fall-biasing response by bringing the mass of the torso 104 closer to the locomotion base 102. Alternatively, the leg may be a single rigid leg without telescoping capability, connecting the wheeled mobile base to the torso 104 at a fixed height. Such a rigid leg configuration reduces mechanical complexity and the number of actuated joints while still providing the structural connection between the locomotion base 102 and the torso 104 that supports the high aspect ratio form factor.

With reference again to the illustrated embodiment, the torso 104 may carry two arms positioned on the sides of the torso 104, similar to the location of human arms. Each arm may include an upper segment and a lower segment similar to a human arm, providing articulation that enables the arms to reach, grasp, and manipulate objects in the environment. The arms may be large enough to pick up objects from the ground when the leg is collapsed, enabling the robot system 100 to retrieve items from floor level by lowering the torso 104 via the telescoping joint and extending the arms downward. This combination of the telescoping leg and the articulated arms provides the robot system 100 with a range of motion that spans from floor level to elevated surfaces, supporting a variety of domestic tasks such as picking up dropped items, placing objects on shelves, and interacting with appliances and fixtures at different heights throughout a home environment.

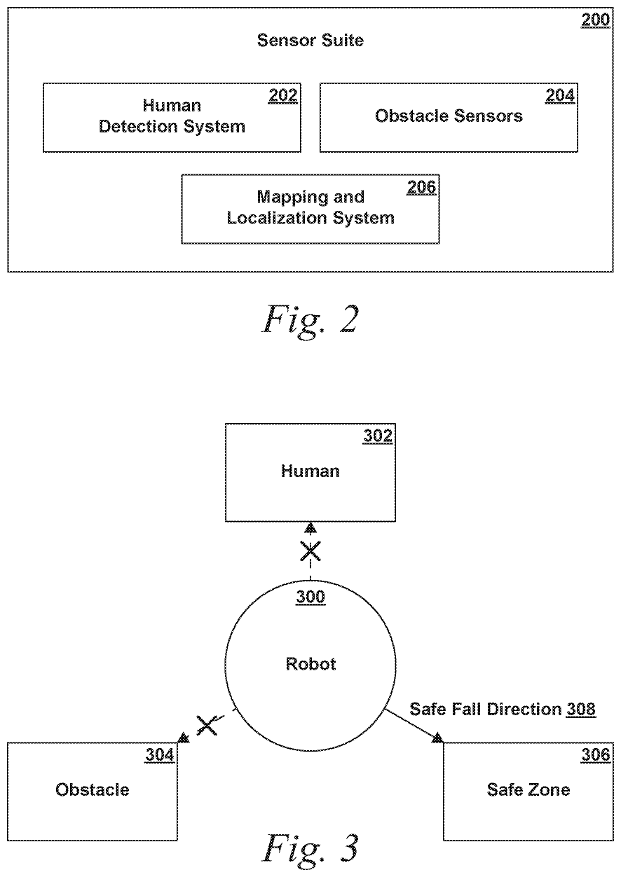

Referring to FIG. 2, a sensor suite 200 comprises a human detection system 202, obstacle sensors 204, and a mapping and localization system 206. The sensor suite 200 provides the environmental data that the safety controller 110 uses to determine the safe fall direction, and the components of the sensor suite 200 work together to build a comprehensive understanding of the robot's surroundings that informs both normal operation and safety event responses. The human detection system 202 is configured to identify a presence and location of one or more humans in proximity to the robot system 100, enabling the safety controller 110 to track where humans are positioned relative to the robot and to prioritize directing falls away from detected humans when a fault condition occurs. The human detection system 202 may employ various sensing modalities to detect and localize humans, including visual sensors such as cameras that capture images or video of the environment, depth sensors that measure distances to objects and can distinguish human body shapes from other objects based on geometric characteristics, thermal sensors that detect the heat signatures characteristic of human bodies, and combinations of these sensing modalities that provide redundant or complementary information about human presence and position. In certain implementations, the human detection system 202 may employ machine learning algorithms trained to recognize human forms, poses, and movements from sensor data, enabling the system to distinguish humans from other objects in the environment even when the humans are partially occluded, in unusual positions, or moving through the scene. The human detection system 202 may continuously update the positions of detected humans as the humans move through the environment, maintaining a real-time map of human locations that the safety controller 110 can query when determining the safe fall direction.

The obstacle sensors 204 are configured to identify objects and structural features in the environment surrounding the robot system 100. These objects and structural features may include furniture, walls, doorways, appliances, equipment, and other items in the environment. The obstacle sensors 204 may employ ranging technologies such as lidar, ultrasonic sensors, or time-of-flight cameras that measure distances to surfaces in the environment, building a spatial representation of nearby objects that the safety controller 110 can use to identify directions where obstacles are present and directions where the space is relatively clear. In some cases, certain structural features such as walls may represent desirable fall targets rather than obstacles to be avoided. For example, falling against a wall may be preferable to falling onto the floor, as the wall can arrest the fall and prevent the robot from reaching a fully horizontal position, potentially reducing impact forces and facilitating subsequent recovery. Accordingly, the safety controller 110 may factor this distinction into the determination of the safe fall direction by identifying nearby walls as potential fall targets when appropriate. Conversely, the obstacle sensors 204 may identify structural features such as stairs, ledges, or drop-offs where a fall in that direction could result in the robot tumbling down stairs or falling off an elevated surface, which would compound the severity of the fall event. The obstacle sensors 204 may also identify sensitive equipment or fragile objects that should be avoided during a fall, such as electronic devices, glassware, or medical equipment in healthcare settings, enabling the safety controller 110 to factor the presence of such items into the determination of the safe fall direction. In warehouse or logistics environments, the obstacle sensors 204 may identify moving equipment such as forklifts or conveyor systems, as well as inventory that could be damaged or displaced by contact with a falling robot.

The mapping and localization system 206 is configured to identify designated safe zones within an environment. The mapping and localization system 206 may build and maintain a map of the environment in which the robot system 100 operates, with the map including information about the layout of spaces, the locations of permanent fixtures, and designated areas that have been identified as safe zones for fault-state landings. These safe zones may be areas that are typically unoccupied by humans, areas with soft flooring or padding that would cushion a fall, areas away from sensitive equipment, or areas that have been specifically designated by an operator or installer as appropriate locations for the robot to fall if a fault condition occurs. The mapping and localization system 206 may determine the robot's current position within the mapped environment using techniques such as simultaneous localization and mapping (SLAM), landmark recognition, or integration of odometry data from the locomotion base 102, and this position information enables the safety controller 110 to determine the direction from the robot's current location toward the nearest safe zone. Furthermore, the map maintained by the mapping and localization system 206 may include information about prohibited fall directions, such as directions toward areas containing hazardous materials, areas with fragile equipment, or areas where humans are frequently present, and the safety controller 110 may use this information to exclude certain directions from consideration when determining the safe fall direction. The mapping and localization system 206 may receive updates to the map over time as the environment changes, as new safe zones are designated, or as previously safe areas become occupied or obstructed, ensuring that the safety controller 110 has current information about the environment when making fall direction determinations.

With reference again to the illustrated embodiment, the sensor suite 200 provides data to the safety controller 110 on a continuous basis during operation of the robot system 100, enabling the safety controller 110 to maintain an up-to-date understanding of the environment and to precompute the safe fall direction based on current conditions. The safety controller 110 may integrate data from the human detection system 202, the obstacle sensors 204, and the mapping and localization system 206 to build a composite picture of the environment that accounts for the positions of humans, the locations of obstacles and sensitive equipment, and the positions of designated safe zones relative to the robot's current location. Based on this composite picture, the safety controller 110 may determine the safe fall direction by prioritizing directing falls away from detected humans and toward the designated safe zones, with secondary considerations including accounting for obstacles and structural features (some of which may represent desirable fall targets), sensitive equipment, and prohibited fall directions identified in the map. The safety controller 110 may store actuation parameters corresponding to the determined safe fall direction, and these stored parameters may be updated as the environmental conditions change—for example, as humans move through the environment, as the robot moves to a new location, or as new obstacles are detected. This continuous monitoring and precomputation approach allows the safety controller 110 to respond rapidly when a fault condition is detected, retrieving the stored actuation parameters and commanding the at least one reaction wheel 106 to generate the biasing torque without requiring real-time computation of the safe fall direction after the fault has already occurred.

Referring to FIG. 3, a robot 300 determines a safe fall direction 308 based on the positions of one or more humans 302, an obstacle 304, and a safe zone 306 in the environment surrounding the robot 300. FIG. 3 illustrates a schematic top-down view of the robot 300 within an environment where the human(s) 302 are positioned to one side of the robot 300, the obstacle 304 is positioned in another direction, and the safe zone 306 is positioned in yet another direction, with the safe fall direction 308 extending from the robot 300 toward the safe zone 306 and away from both the human(s) 302 and the obstacle 304. The safety controller 110, as described above with reference to FIG. 1, receives data from the sensor suite 108 including the human detection system 202, the obstacle sensors 204, and the mapping and localization system 206, and the safety controller 110 uses this data to evaluate the relative positions of detected humans, obstacles, and safe zones with respect to the robot's current location and orientation. Based on this evaluation, the safety controller 110 determines the safe fall direction 308 by identifying a direction that maximizes distance from detected humans while also directing the fall trajectory toward a designated safe zone when such a zone is available within the reachable fall envelope. The determination process may involve computing angular sectors around the robot 300 that are occupied by humans, obstacles, or other hazards, and identifying the angular sector or direction that provides the greatest safety margin when all factors are considered together.

The safety controller 110 is configured to determine the safe fall direction 308 by prioritizing directing falls away from detected human(s) 302 and toward the designated safe zone 306. This prioritization reflects the recognition that human safety represents a primary concern in environments where dynamically stable robots operate alongside people, and that directing a fall away from humans reduces the risk of injury even if other aspects of the fall trajectory are suboptimal. When the human detection system 202 identifies one or more humans in proximity to the robot 300, the safety controller 110 assigns a high priority to excluding directions toward those humans from consideration as potential fall directions, effectively treating the angular sectors occupied by detected humans as prohibited zones for the fall trajectory. The safety controller 110 may also consider the velocity and predicted movement of detected humans when determining the safe fall direction 308, accounting for the possibility that a human who is currently in one location may move to a different location during the time interval between fault detection and the completion of the fall, and adjusting the safe fall direction 308 accordingly to maintain separation from the predicted human position. Furthermore, the safety controller 110 may apply a safety margin around detected humans, treating not just the current position of each human but also a surrounding buffer zone as a prohibited area for the fall trajectory, thereby providing additional protection against uncertainty in human position estimates or unexpected human movements.

In addition to prioritizing falls away from detected humans, the safety controller 110 is configured to direct falls toward the designated safe zone 306 when such a zone is present within the environment and reachable from the robot's current position. The mapping and localization system 206 maintains information about designated safe zones within the mapped environment, and the safety controller 110 queries this information to identify the direction from the robot's current location toward the nearest safe zone or toward the safe zone that provides the most favorable fall outcome based on factors such as distance, floor surface characteristics, and absence of obstacles along the fall path. Directing falls toward designated safe zones may provide benefits beyond simply avoiding humans and obstacles; for example, a safe zone may be an area with padded flooring that cushions the impact of a fall, an area that is typically unoccupied and therefore unlikely to have humans present even if the human detection system does not currently detect anyone in that area, or an area that has been specifically prepared for robot fault events with features such as charging stations or maintenance access points. The safety controller 110 may weigh the desirability of reaching a designated safe zone against the distance to that zone and the torque required to bias the fall trajectory sufficiently to reach the zone, selecting a fall direction that balances these considerations to achieve a favorable outcome given the constraints of the situation.

The determination of the safe fall direction 308 may also account for the obstacle 304 and other obstacles detected by the obstacle sensors 204, with the safety controller 110 evaluating whether each obstacle represents a hazard to be avoided or a structural feature that may beneficially arrest the fall. In certain scenarios, falling against a wall or other solid structural feature may be preferable to falling onto the floor, as the structural feature can stop the robot's motion before the robot reaches a fully horizontal position, potentially reducing impact forces and facilitating subsequent recovery. The safety controller 110 may distinguish between obstacles that should be avoided, such as fragile equipment, furniture that could be damaged or displaced, or objects that could create secondary hazards if struck, and structural features that may serve as beneficial fall targets, such as walls or sturdy fixtures that can absorb the robot's momentum without damage. When the obstacle 304 represents a hazard to be avoided, the safety controller 110 excludes directions toward the obstacle 304 from consideration as potential fall directions, similar to the treatment of directions toward detected humans. When the obstacle 304 or another structural feature represents a potential beneficial fall target, the safety controller 110 may include that direction as a candidate for the safe fall direction 308, weighing the benefits of falling against the structural feature against other factors such as the positions of humans and designated safe zones.

With reference again to the illustrated embodiment, the safe fall direction 308 shown in FIG. 3 represents the result of the safety controller's determination process, with the direction extending away from the human(s) 302 and the obstacle 304 and toward the safe zone 306. The safety controller 110 stores actuation parameters corresponding to the safe fall direction 308, and these actuation parameters specify the commands to be sent to the at least one reaction wheel 106 to generate a biasing torque in the direction of the safe fall direction 308 when a fault condition is detected. As described previously, the safety controller 110 may update the stored actuation parameters as environmental conditions change, such as when the human(s) 302 move to different positions, when the robot 300 moves to a different location within the environment, or when new obstacles are detected or previously detected obstacles are no longer present. This continuous updating ensures that the stored actuation parameters reflect current conditions at the time a fault condition occurs, enabling the safety controller 110 to implement an appropriate fall-biasing response without requiring real-time computation of the safe fall direction after the fault has already been detected. The prioritization of directing falls away from detected human(s) 302 and toward the designated safe zone 306 remains consistent throughout this continuous updating process, with the safety controller 110 applying the same prioritization criteria to each updated determination of the safe fall direction 308.

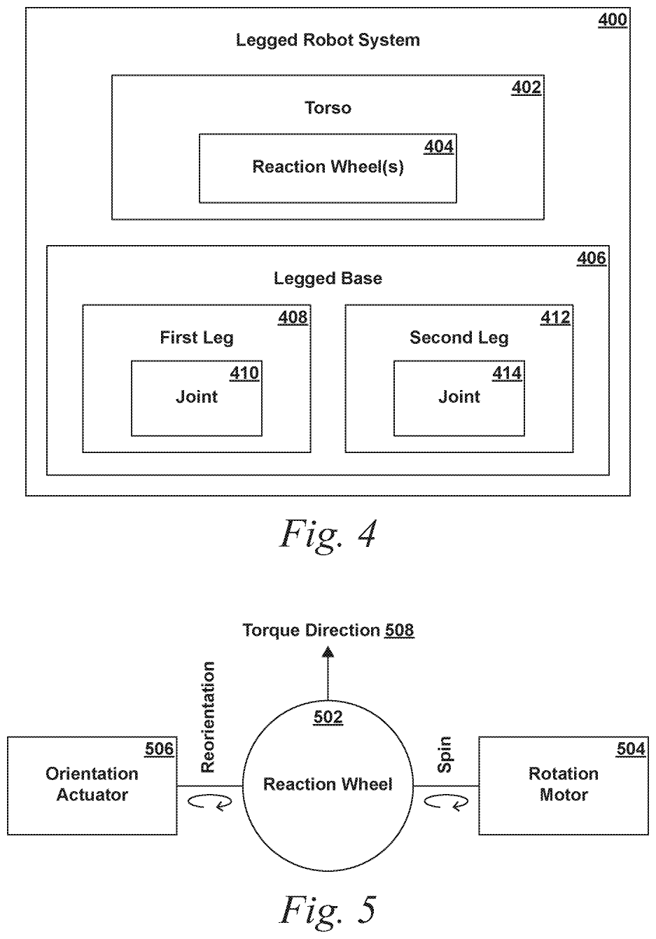

Referring to FIG. 4, a legged robot system 400 comprises a torso 402 with at least one reaction wheel 404 mounted therein, and a legged base 406 including a first leg 408 with a joint 410 and a second leg 412 with a joint 414. The legged base 406 may comprise a bipedal humanoid configuration, with the first leg 408 and the second leg 412 arranged in a manner analogous to human legs to support and locomote the legged robot system 400. The bipedal humanoid configuration enables the legged robot system 400 to navigate environments designed for humans, including spaces with stairs, uneven terrain, and obstacles that may be difficult for wheeled platforms to traverse, while maintaining a form factor that is familiar and intuitive for human users to interact with. The torso 402 is carried by the legged base 406 and houses the at least one reaction wheel 404 within an enclosed structure, similar to the housing 112 described previously with reference to FIG. 1, such that the reaction wheel 404 is contained within the torso 402 and is not accessible from outside the torso 402 during operation or during a fall-biasing response. The legged robot system 400 may include a sensor suite and a safety controller configured to monitor environmental conditions, determine a safe fall direction, detect a fault condition, and actuate the at least one reaction wheel 404 to generate a biasing torque that influences a fall trajectory of the legged robot system 400 toward the safe fall direction, as described above with reference to the robot system 100.

The joint 410 of the first leg 408 and the joint 414 of the second leg 412 are each configured to adjust a height of the torso 402 relative to a ground surface. The joints 410, 414 may comprise actuated joints such as knee joints, hip joints, or ankle joints that can be commanded to flex or extend, thereby raising or lowering the torso 402 with respect to the ground surface on which the legged base 406 stands. In certain implementations, the joints 410, 414 may include multiple degrees of freedom that enable not only height adjustment but also forward and lateral movement of the torso 402 relative to the legged base 406, providing the legged robot system 400 with a range of postures and configurations that can be adopted during normal operation or during safety events. The ability to adjust the height of the torso 402 enables the legged robot system 400 to interact with objects and surfaces at various elevations, to navigate under low obstacles by crouching, and to adopt postures that are appropriate for different tasks such as picking up objects from the floor or reaching elevated shelves. Furthermore, the height adjustment capability provided by the joints 410, 414 serves a function during safety events by enabling the safety controller to lower the center of gravity of the legged robot system 400 when a fault condition is detected, as described in further detail below.

The safety controller is configured to actuate the joint 410 and the joint 414 to lower a center of gravity of the legged robot system 400 upon detecting the fault condition. When the safety controller detects a fault condition such as power loss, instability detection indicating that the legged robot system 400 has exceeded stability thresholds, or a human-proximity limit breach, the safety controller may command the joints 410, 414 to flex in a manner that brings the torso 402 closer to the ground surface, thereby lowering the center of gravity of the legged robot system 400. Lowering the center of gravity reduces the potential energy of the system and decreases the severity of impact forces that may result from a fall, as the torso 402 has less distance to travel before reaching the ground surface. Additionally, lowering the center of gravity reduces the moment arm between the center of gravity and the ground contact points of the legged base 406, which in turn reduces the torque required from the at least one reaction wheel 404 to bias the fall trajectory in the desired direction. This coordination between the joint actuation that lowers the center of gravity and the reaction wheel actuation that generates the biasing torque enables the legged robot system 400 to achieve more effective fall direction control than would be possible with either mechanism alone. The safety controller may command the joints 410, 414 to lower the torso 402 simultaneously with or prior to actuating the at least one reaction wheel 404, depending on the timing constraints of the particular fault condition and the response characteristics of the joint actuators and reaction wheel motors.

In alternative embodiments, the legged base 406 may comprise configurations other than the bipedal humanoid configuration, such as quadrupedal configurations with four legs or hexapod configurations with six legs, each of which may include joints configured to adjust the height of the torso 402 relative to the ground surface. The principles of using torso-mounted reaction wheels to bias fall direction and coordinating reaction wheel actuation with joint actuation to lower the center of gravity apply across these various legged configurations, with the specific joint commands and actuation sequences adapted to the particular kinematic structure of each configuration. Moreover, the legged base 406 may include additional joints beyond those specifically described, such as ankle joints that provide additional degrees of freedom for balance and locomotion, and the safety controller may actuate any or all of these joints in coordination with the at least one reaction wheel 404 during a safety event to achieve the desired fall direction control and center of gravity lowering.

With reference again to the illustrated embodiment, the legged robot system 400 shown in FIG. 4 represents a configuration where the at least one reaction wheel 404 is mounted within the torso 402 and the legged base 406 provides both locomotion capability and the ability to adjust the height of the torso 402 through actuation of the joints 410, 414. The legged base 406 is configured to support and locomote the legged robot system 400, with the first leg 408 and the second leg 412 providing the structural support and the actuated joints 410, 414 enabling both walking locomotion and height adjustment. The safety controller monitors environmental conditions using the sensor suite, determines the safe fall direction based on the positions of detected humans, obstacles, and safe zones as described previously with reference to FIG. 3, and stores actuation parameters corresponding to the safe fall direction for retrieval upon detecting a fault condition. Upon detecting the fault condition, the safety controller retrieves the stored actuation parameters, commands the joints 410, 414 to lower the center of gravity of the legged robot system 400, and actuates the at least one reaction wheel 404 to generate the biasing torque that influences the fall trajectory toward the safe fall direction. This coordinated response leverages both the reaction wheel capability to actively generate torque and the joint capability to lower the center of gravity, providing the legged robot system 400 with enhanced fall direction control during safety events.

Referring to FIG. 5, a reorientable single-wheel configuration is illustrated in which a reaction wheel 502 is mounted on an actuated joint that allows a rotational axis of the reaction wheel 502 to be dynamically reoriented. The reaction wheel 502 is driven by a rotation motor 504 that spins the reaction wheel 502 to generate torque in a torque direction 508, and an orientation actuator 506 reorients the rotational axis of the reaction wheel 502 to change the direction of the generated torque. In this configuration, the reaction wheel 502 may be mounted on an actively variable axis such that the orientation of the rotational axis can be adjusted on the fly as per torque requirements, enabling the system to generate biasing torque in any desired direction by mechanically reorienting the reaction wheel 502 rather than by combining outputs from multiple fixed-axis reaction wheels. The orientation actuator 506 may comprise a motor, servo, or other actuated mechanism that rotates the mounting structure of the reaction wheel 502 about one or more axes, thereby changing the angular orientation of the rotational axis of the reaction wheel 502 with respect to the torso in which the reaction wheel 502 is housed. This reorientable configuration provides directional flexibility through mechanical reorientation, allowing a single reaction wheel 502 to generate torque in the sagittal plane, the frontal plane, or any intermediate direction depending on the orientation established by the orientation actuator 506 prior to or during actuation of the rotation motor 504.

The safety controller 110, as described previously with reference to FIG. 1, is configured to command the orientation actuator 506 to orient the rotational axis of the reaction wheel 502 perpendicular to the safe fall direction 308 prior to actuating the reaction wheel 502 to generate the biasing torque. When the safety controller 110 detects a fault condition, the safety controller 110 retrieves the stored actuation parameters corresponding to the safe fall direction 308 and commands the orientation actuator 506 to rotate the mounting structure of the reaction wheel 502 such that the rotational axis of the reaction wheel 502 is positioned perpendicular to the desired fall trajectory. Once the orientation actuator 506 has positioned the rotational axis in the appropriate orientation, the safety controller 110 commands the rotation motor 504 to accelerate or decelerate the reaction wheel 502, thereby generating a torque about the rotational axis that acts to bias the robot's fall trajectory toward the safe fall direction 308. The perpendicular relationship between the rotational axis and the safe fall direction 308 ensures that the torque generated by the spinning reaction wheel 502 acts in the plane that includes the safe fall direction 308, providing effective influence over the fall trajectory in the desired direction. This sequence of first orienting the rotational axis and then actuating the rotation motor 504 introduces an additional actuation operation compared to fixed-axis multi-wheel configurations, which may add latency to the response; however, the reorientable single-wheel configuration offers reduced weight and mechanical simplicity by requiring fewer reaction wheels and associated motors than multi-wheel configurations.

In alternative embodiments, the orientation actuator 506 may provide multiple degrees of freedom for reorienting the rotational axis of the reaction wheel 502, enabling the rotational axis to be positioned at any orientation within a hemisphere or full sphere of possible orientations rather than being constrained to rotation about a single axis. Such multi-axis orientation capability may be achieved through a gimbal arrangement, a spherical joint with multiple actuators, or other mechanical configurations that provide two or more rotational degrees of freedom for the mounting structure of the reaction wheel 502. Additionally, the safety controller 110 may continuously adjust the orientation of the rotational axis during the fall-biasing response, commanding the orientation actuator 506 to track changes in the desired torque direction as the robot's orientation changes during the fall, thereby maintaining effective torque generation throughout the duration of the fall event rather than generating torque in a fixed direction established at the moment of fault detection. Furthermore, in certain implementations, the safety controller 110 may preemptively orient the rotational axis of the reaction wheel 502 toward the perpendicular of the precomputed safe fall direction 308 during normal operation, such that when a fault condition is detected, the orientation actuator 506 has already positioned the rotational axis appropriately and the rotation motor 504 can begin generating torque immediately without waiting for the orientation operation to complete, thereby reducing the response latency associated with the reorientable single-wheel configuration.

With reference again to the illustrated embodiment, the reaction wheel 502 shown in FIG. 5 represents a configuration where a single reaction wheel mounted on an actuated joint provides full directional flexibility for fall direction biasing through mechanical reorientation of the rotational axis. The rotation motor 504 drives the spin of the reaction wheel 502 to generate torque, and the orientation actuator 506 controls the direction in which that torque is applied by adjusting the orientation of the rotational axis. The torque direction 508 shown in FIG. 5 indicates the direction of the torque generated when the rotation motor 504 actuates the reaction wheel 502, with this torque direction 508 being determined by the orientation of the rotational axis as established by the orientation actuator 506. The safety controller 110 coordinates the operation of the orientation actuator 506 and the rotation motor 504 to generate biasing torque in the safe fall direction 308 when a fault condition is detected, commanding the orientation actuator 506 to position the rotational axis perpendicular to the safe fall direction 308 and then commanding the rotation motor 504 to spin the reaction wheel 502 to generate the biasing torque. This reorientable single-wheel configuration may be implemented in the robot system 100 described with reference to FIG. 1, in the legged robot system 400 described with reference to FIG. 4, or in other dynamically stable robot configurations where the reduced weight and mechanical simplicity of a single reaction wheel are desired and the potential for additional latency associated with the orientation operation is acceptable given the response time constraints of the particular application.

Referring to FIG. 6, a fixed-axis multi-wheel configuration is illustrated in which a first reaction wheel 602 and a second reaction wheel 604 are positioned at an angle to each other within the torso, with individual torque contributions T1 and T2 combining to produce a net torque vector 606 in a desired direction. In this configuration, the first reaction wheel 602 and the second reaction wheel 604 are permanently mounted at defined orientations within the torso, enabling torque generation in both the sagittal plane and the frontal plane without requiring mechanical reorientation of the wheel axes. The reaction wheels may be placed orthogonal to each other, with one reaction wheel in the sagittal plane and the other reaction wheel in the frontal plane, such that the reaction wheel in the sagittal plane provides stability and torque generation for pitch control while the reaction wheel in the frontal plane provides stability and torque generation for roll control. When the reaction wheels are arranged orthogonally, each reaction wheel generates torque about its respective axis independently, and the safety controller 110 can command each reaction wheel to accelerate or decelerate to produce torque contributions that combine vectorially to yield the net torque vector 606 in the safe fall direction 308. This orthogonal arrangement provides direct and independent control over torque in the sagittal and frontal planes, simplifying the control algorithms and enabling rapid response since each reaction wheel can begin generating torque immediately upon detection of a fault condition without requiring coordination with the other reaction wheel to achieve torque in either principal plane.

Alternatively, the first reaction wheel 602 and the second reaction wheel 604 may be placed at an angle in the range of approximately 45 to 75 degrees to each other rather than orthogonally, providing more compact and more symmetrical packaging and weight distribution within the torso. Packaging two large-diameter reaction wheels orthogonally within the torso can present geometric challenges, as the wheels may interfere with each other or require a larger torso volume to accommodate both wheels without overlap. By positioning the first reaction wheel 602 and the second reaction wheel 604 at an angle within this range, such as 60 degrees to each other, the reaction wheels can be arranged in a more compact configuration that reduces the overall volume required within the torso while maintaining the ability to generate torque in both the sagittal plane and the frontal plane through coordinated actuation. Angles within the range of approximately 45 to 75 degrees provide a balance between compact packaging and effective torque generation in both principal planes, with angles closer to 45 degrees providing more compact packaging and angles closer to 75 degrees providing more balanced torque authority between the sagittal and frontal planes. The angled arrangement also provides more symmetrical weight distribution compared to an orthogonal arrangement, as the mass of each reaction wheel is distributed more evenly about the vertical axis of the torso, which may improve the balance characteristics of the robot system 100 during normal operation and reduce asymmetric loading on the locomotion base 102. Moreover, the angled configuration may enable the reaction wheels to be optimized for large inertia to weight ratio by using large-diameter flywheels, as the angled arrangement may accommodate larger wheel diameters than would be possible with orthogonally arranged wheels of the same diameter within a given torso volume.

In an angled reaction wheel configuration where the first reaction wheel 602 and the second reaction wheel 604 are positioned at an angle within the range of approximately 45 to 75 degrees to each other, such as 60 degrees, the net torque produced in the sagittal plane may differ from the torque produced in the frontal plane when both reaction wheels are actuated at the same rate. Because the rotational axes of the two reaction wheels are not aligned with the sagittal and frontal planes but rather are oriented at angles to both planes, the torque contribution from each reaction wheel has components in both the sagittal and frontal directions, and the magnitudes of these components depend on the angle between the reaction wheel axes and the respective planes. The specific torque asymmetry characteristics will vary depending on the angle selected within the range; for example, when the first reaction wheel 602 and the second reaction wheel 604 are positioned at 60 degrees to each other and symmetrically disposed about the sagittal plane, the combined torque contributions in the sagittal direction are greater than the combined torque contributions in the frontal direction for equal actuation of both wheels, resulting in a net torque in the sagittal plane that exceeds the net torque in the frontal plane. This asymmetry in torque capability between the sagittal and frontal planes may be acceptable or even desirable in certain applications where greater torque authority is needed in the sagittal plane than in the frontal plane, such as when the robot system 100 is more likely to experience disturbances or fault conditions that require pitch correction than roll correction. Furthermore, the safety controller 110 may compensate for this asymmetry by commanding different actuation rates for the first reaction wheel 602 and the second reaction wheel 604 when generating torque in the frontal plane, thereby achieving the desired net torque vector 606 in any direction despite the inherent asymmetry of the angled configuration.

The motors that drive the first reaction wheel 602 and the second reaction wheel 604 may be colocated along the axis of the respective reaction wheels, forming a direct drive configuration in which each motor drives the corresponding reaction wheel directly without intermediate gearing or transmission components. This direct drive arrangement reduces mechanical complexity by eliminating gears, belts, or other transmission elements that could introduce backlash, friction losses, or points of mechanical failure. Furthermore, the direct coupling between each motor and its associated reaction wheel may enable precise control over the angular acceleration of the reaction wheel for responsive torque generation. The colocated motor arrangement also contributes to compact packaging within the torso, as each motor-reaction wheel assembly forms a self-contained unit that can be mounted at the desired orientation without requiring additional space for transmission components extending beyond the wheel envelope. Additionally, the reaction wheels can be optimized for large inertia to weight ratio, making large-diameter flywheels desirable since a larger diameter provides greater rotational inertia for a given mass, enabling the reaction wheels to store more angular momentum and generate greater torque for a given angular acceleration of the flywheel. The optimization for large inertia to weight ratio may involve selecting materials with high density for the rim of each reaction wheel while using lighter materials for the hub and spokes, concentrating the mass at the outer diameter where the mass contributes most effectively to the rotational inertia.

In alternative embodiments, counterparts of the reaction wheels may be implemented using different hardware configurations that provide similar torque generation capabilities while offering distinct trade-offs in terms of size, weight, response characteristics, and power consumption. Control moment gyroscopes represent one such alternative, where a spinning rotor is mounted on a gimbal that can be tilted to change the direction of the angular momentum vector, thereby generating torque through gyroscopic precession rather than through changes in rotor speed. Control moment gyroscopes can generate larger torques for a given rotor size compared to reaction wheels because the torque output depends on the gimbal rate rather than on the rotor acceleration, but control moment gyroscopes introduce additional mechanical complexity through the gimbal mechanism and may exhibit singularities in certain orientations where torque generation capability is reduced. Another alternative involves variable-speed control moment gyroscopes that combine the principles of reaction wheels and control moment gyroscopes by allowing both rotor speed changes and gimbal tilting, providing enhanced torque authority and avoiding singularities at the cost of increased control complexity. Momentum wheels, which are reaction wheels that maintain a constant bias speed rather than operating around zero speed, may be employed in configurations where continuous angular momentum storage is beneficial for attitude stabilization during normal operation, with the bias speed providing a baseline angular momentum that can be modulated to generate torque. Additionally, the reaction wheel function may be distributed across multiple smaller wheels rather than concentrated in one or two larger wheels, with arrays of smaller reaction wheels providing redundancy such that the failure of any single wheel does not eliminate the fall direction biasing capability, though such distributed configurations may require more complex coordination algorithms and may occupy more total volume within the torso than configurations using fewer larger wheels.

With reference again to the illustrated embodiment, the safety controller 110 is configured to actuate the first reaction wheel 602 and the second reaction wheel 604 in coordinated fashion to generate the net torque vector 606 in the safe fall direction 308 by combining outputs from the two reaction wheels in varying proportions. When the safety controller 110 detects a fault condition and retrieves the stored actuation parameters corresponding to the safe fall direction 308, the safety controller 110 determines the appropriate actuation commands for each of the first reaction wheel 602 and the second reaction wheel 604 based on the direction of the net torque vector 606 required to bias the fall trajectory toward the safe fall direction 308. The safety controller 110 commands each reaction wheel to accelerate or decelerate at a rate that produces a torque contribution in the direction and magnitude needed such that the vector sum of the torque contributions from the first reaction wheel 602 and the second reaction wheel 604 equals the desired net torque vector 606. For example, if the safe fall direction 308 lies in the sagittal plane, the safety controller 110 may command both reaction wheels to generate torque contributions that combine constructively in the sagittal direction while canceling in the frontal direction, whereas if the safe fall direction 308 lies in the frontal plane, the safety controller 110 may command the reaction wheels to generate torque contributions that combine constructively in the frontal direction while canceling in the sagittal direction. When the safe fall direction 308 lies at an intermediate angle between the sagittal and frontal planes, the safety controller 110 commands the first reaction wheel 602 and the second reaction wheel 604 to generate torque contributions in proportions that yield a net torque vector 606 at the desired intermediate angle, with the relative magnitudes of the actuation commands for each reaction wheel determined by the geometric relationship between the reaction wheel axes and the desired torque direction.

The magnitude of the biasing torque generated by the reaction wheel system can be controlled by varying the rate of angular acceleration or deceleration commanded to the reaction wheel motors, with higher acceleration rates producing greater torque magnitudes and lower acceleration rates producing smaller torque magnitudes. This torque magnitude control enables the safety controller 110 to tailor the fall-biasing response to the specific circumstances of each fault event, applying greater torque when the robot system 100 has substantial momentum in an undesired direction or when the safe fall direction 308 requires a significant trajectory change, and applying lesser torque when a gentler correction is sufficient or when excessive torque could cause the robot to overshoot the desired fall direction. The relationship between commanded acceleration and generated torque follows from the fundamental dynamics of reaction wheels, where the torque produced equals the product of the wheel's moment of inertia and its angular acceleration; thus, reaction wheels with larger moments of inertia can generate greater torques for a given acceleration rate, or alternatively can achieve a given torque with a lower acceleration rate that may be easier for the motor to sustain. The safety controller 110 may modulate the torque magnitude based on sensor feedback during the fall, increasing torque if the fall trajectory is not converging toward the safe fall direction 308 as rapidly as needed, or decreasing torque as the trajectory approaches the desired direction to avoid overcorrection. This torque magnitude control applies to both classes of reaction wheel configurations described herein: in the fixed-axis multi-wheel configuration, the safety controller 110 controls torque magnitude by commanding appropriate acceleration rates to the first reaction wheel 602 and the second reaction wheel 604, with the net torque magnitude determined by the combined contributions from both wheels; in the reorientable single-wheel configuration, the safety controller 110 controls torque magnitude by commanding the appropriate acceleration rate to the rotation motor 504 after the orientation actuator 506 has positioned the rotational axis perpendicular to the safe fall direction 308. Furthermore, the torque magnitude may be constrained by the current rotational state of the reaction wheels, as a reaction wheel that is already spinning near its maximum speed in one direction has limited capacity to accelerate further in that direction but substantial capacity to decelerate or reverse, and the safety controller 110 accounts for these constraints when determining the achievable torque magnitude for a given fall-biasing response.

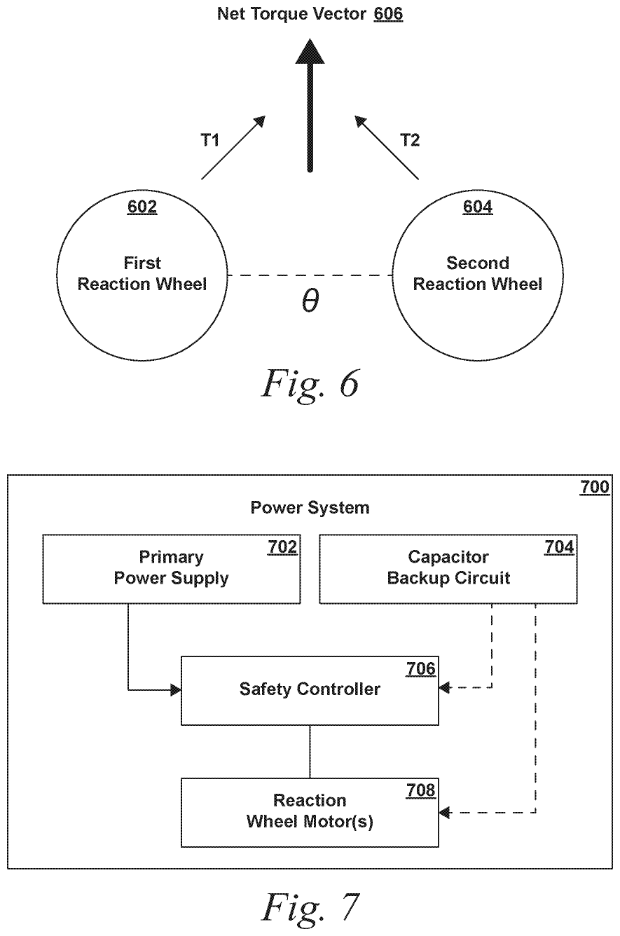

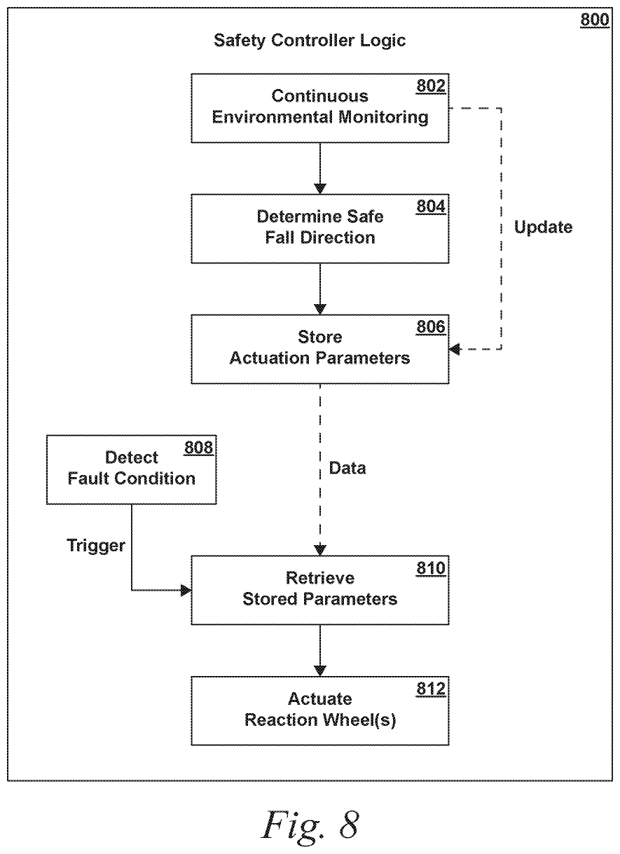

Referring to FIG. 7, a power system 700 comprises a primary power supply 702 and a capacitor backup circuit 704 that provides backup power to a safety controller 706 and reaction wheel motor(s) 708 upon detection of a power loss. The primary power supply 702 may comprise a battery pack, a rechargeable battery system, or another power source that provides electrical power to the robot system 100 during normal operation, with the primary power supply 702 delivering power to the locomotion base 102, the torso 104, the sensor suite 108, the safety controller 706, and the reaction wheel motor(s) 708 that drive the at least one reaction wheel 106. During normal operation when the primary power supply 702 is functioning properly, the safety controller 706 receives power from the primary power supply 702 and performs the continuous environmental monitoring, safe fall direction determination, and storage of actuation parameters as described subsequently with reference to FIG. 8. The reaction wheel motor(s) 708 also receive power from the primary power supply 702 during normal operation, enabling the reaction wheel motor(s) 708 to drive the at least one reaction wheel 106 for balance maintenance, disturbance rejection, and counteracting destabilizing forces during movement. The capacitor backup circuit 704 is connected to the primary power supply 702 and maintains a charge during normal operation, with the capacitor backup circuit 704 storing electrical energy that can be released to power the safety controller 706 and the reaction wheel motor(s) 708 when the primary power supply 702 fails or becomes unavailable.

Upon detection of a power loss from the primary power supply 702, the capacitor backup circuit 704 transitions to providing backup power to the safety controller 706 and the reaction wheel motor(s) 708, enabling the fall-biasing safety function to execute even when the primary power systems are compromised. The detection of power loss may be performed by monitoring circuitry within the power system 700 that senses a drop in voltage or current from the primary power supply 702 below a threshold level, and upon detecting such a drop, the monitoring circuitry triggers the transition to backup power from the capacitor backup circuit 704. This transition may occur rapidly, within milliseconds of detecting the power loss, to minimize any interruption in power delivery to the safety controller 706 and the reaction wheel motor(s) 708 during the transition period. The capacitor backup circuit 704 may comprise one or more capacitors, supercapacitors, or ultracapacitors that are capable of storing sufficient electrical energy and delivering that energy at the power levels required by the safety controller 706 and the reaction wheel motor(s) 708 during the fall-biasing response. Capacitors are well-suited for this backup power application because capacitors can discharge rapidly to deliver high current for short durations, which matches the power profile of the fall-biasing response where the reaction wheel motor(s) 708 may require substantial current to accelerate or decelerate the at least one reaction wheel 106 quickly enough to generate the biasing torque before the robot system 100 completes its fall.

The capacitor backup circuit 704 stores sufficient energy to power actuation of the at least one reaction wheel 106 for the duration of a fall-biasing response, ensuring that the safety function can complete its operation from the moment of fault detection through the generation of the biasing torque that influences the fall trajectory toward the safe fall direction 308. The duration of a fall-biasing response may be on the order of hundreds of milliseconds to a few seconds, depending on the height of the robot system 100, the initial conditions at the time of fault detection, and the magnitude of biasing torque required to redirect the fall trajectory toward the safe fall direction 308. The energy storage capacity of the capacitor backup circuit 704 is sized to provide power throughout this duration, accounting for the power consumption of the safety controller 706 to retrieve the stored actuation parameters and generate the actuation commands, the power consumption of the reaction wheel motor(s) 708 to accelerate or decelerate the at least one reaction wheel 106 according to the actuation commands, and any power consumption by sensors or other components that remain active during the fall-biasing response. In certain implementations, the capacitor backup circuit 704 may be sized with a margin above the minimum energy required for the fall-biasing response, providing additional capacity to account for variations in the duration or power requirements of different fall scenarios, degradation of capacitor performance over time, or operation in temperature extremes that may affect capacitor performance.

In alternative embodiments, the capacitor backup circuit 704 may also provide backup power to components of the sensor suite 108 that are used during the fall-biasing response, such as inertial measurement units that provide orientation and angular velocity data to the safety controller 706 for closed-loop control of the reaction wheel actuation during the fall. The safety controller 706 may use this sensor data to adjust the actuation commands in real time as the robot's orientation changes during the fall, maintaining effective torque generation throughout the duration of the fall event rather than relying solely on open-loop actuation based on the stored actuation parameters. Additionally, the capacitor backup circuit 704 may provide backup power to the orientation actuator 506 in embodiments that employ the reorientable single-wheel configuration described with reference to FIG. 5, enabling the orientation actuator 506 to position the rotational axis of the reaction wheel 502 perpendicular to the safe fall direction 308 even when the primary power supply 702 has failed. Furthermore, in embodiments where the robot system 100 includes a telescoping leg connecting the locomotion base 102 to the torso 104, the capacitor backup circuit 704 may provide backup power to the actuator that retracts the telescoping leg, enabling the safety controller 706 to lower the center of gravity of the robot system 100 as part of the coordinated fall-biasing response even during a power loss event.

With reference again to the illustrated embodiment, the power system 700 shown in FIG. 7 provides a configuration where the capacitor backup circuit 704 ensures that the fall-biasing safety function remains available precisely when the safety function is most needed, namely during fault conditions that may include complete failure of the primary power supply 702. The safety controller 706 operates independently of the main power supply when powered by the capacitor backup circuit 704, executing the fall-biasing response by retrieving the stored actuation parameters and commanding the reaction wheel motor(s) 708 to generate the biasing torque in the safe fall direction 308. The reaction wheel motor(s) 708 receive sufficient power from the capacitor backup circuit 704 to accelerate or decelerate the at least one reaction wheel 106 at the rates specified by the actuation commands, generating the biasing torque that influences the fall trajectory of the robot system 100 toward the safe fall direction 308 as determined by the safety controller based on the environmental conditions detected by the sensor suite 108 prior to the power loss. This backup power capability addresses the scenario where power loss itself is the fault condition that triggers the safety response, ensuring that the robot system 100 can execute a controlled fall toward a safer direction rather than falling in an uncontrolled manner that may pose greater risk to nearby humans, sensitive equipment, or the robot system 100 itself.

Referring to FIG. 8, safety controller logic 800 illustrates the operational flow of the safety controller 110 described previously with reference to FIG. 1, showing how the safety controller 110 processes environmental data and prepares for potential fault conditions through preemptive determination of the safe fall direction 308. The safety controller logic 800 comprises continuous environmental monitoring 802 that feeds into safe fall direction determination 804, which in turn generates and maintains stored actuation parameters 806 that specify the commands to be sent to the at least one reaction wheel 106 when a fault condition occurs. The continuous environmental monitoring 802 receives data from the sensor suite 108, including data from the human detection system 202 regarding the presence and location of one or more humans in proximity to the robot system 100, data from the obstacle sensors 204 regarding the positions of objects and structural features in the environment, and data from the mapping and localization system 206 regarding the robot's current position within the mapped environment and the locations of designated safe zones. This continuous monitoring operates throughout the normal operation of the robot system 100, maintaining an up-to-date understanding of the environmental conditions that would inform the selection of a safe fall direction 308 if a fault condition were to occur. The continuous environmental monitoring 802 processes the incoming sensor data to track changes in the positions of detected humans as the humans move through the environment, to identify new obstacles that enter the sensor field of view or previously detected obstacles that are no longer present, and to update the robot's position within the mapped environment as the robot system 100 moves from one location to another.

The safe fall direction determination 804 receives the processed environmental data from the continuous environmental monitoring 802 and applies the prioritization criteria described previously with reference to FIG. 3 to determine the safe fall direction 308 based on the current environmental conditions. The safe fall direction determination 804 evaluates the relative positions of detected humans, obstacles, and safe zones with respect to the robot's current location and orientation, identifying angular sectors around the robot system 100 that are occupied by humans or hazardous obstacles and angular sectors that are clear or that contain designated safe zones toward which a fall could be directed. Based on this evaluation, the safe fall direction determination 804 selects the safe fall direction 308 by prioritizing directing falls away from detected human(s) 302 and toward the designated safe zone 306 when such a zone is available within the reachable fall envelope, with secondary considerations including the positions of obstacles and structural features that may serve as beneficial fall targets or that should be avoided. The safe fall direction determination 804 then calculates the actuation commands for the at least one reaction wheel 106 based on the environmental conditions, determining the specific motor commands that would generate a biasing torque in the direction of the safe fall direction 308 when executed by the reaction wheel motor(s) 708. For embodiments employing the fixed-axis multi-wheel configuration described with reference to FIG. 6, the safe fall direction determination 804 calculates the relative actuation rates for the first reaction wheel 602 and the second reaction wheel 604 that would produce a net torque vector 606 aligned with the safe fall direction 308, accounting for the geometric relationship between the reaction wheel axes and the desired torque direction. For embodiments employing the reorientable single-wheel configuration described with reference to FIG. 5, the safe fall direction determination 804 calculates the orientation command for the orientation actuator 506 that would position the rotational axis of the reaction wheel 502 perpendicular to the safe fall direction 308, as well as the actuation command for the rotation motor 504 that would generate the biasing torque once the orientation is established.

The stored actuation parameters 806 comprise the calculated actuation commands generated by the safe fall direction determination 804, with these parameters stored in memory accessible to the safety controller 110 for rapid retrieval when a fault condition is detected. The stored actuation parameters 806 may include motor speed commands, motor torque commands, acceleration profiles, or other control parameters that specify how the reaction wheel motor(s) 708 should be actuated to generate the biasing torque in the safe fall direction 308. By storing these actuation parameters in advance, the safety controller 110 can respond to a fault condition without requiring real-time computation of the safe fall direction 308 or the corresponding actuation commands after the fault has already been detected, thereby reducing the response latency and enabling faster torque generation when milliseconds may be significant for safety outcomes. The safety controller 110 is configured to update the stored actuation parameters 806 as the environmental conditions change, with the safe fall direction determination 804 recalculating the actuation commands whenever the continuous environmental monitoring 802 detects a change in the positions of humans, obstacles, or the robot system 100 itself that would affect the selection of the safe fall direction 308. This continuous updating ensures that the stored actuation parameters 806 reflect current conditions at the time a fault condition occurs, rather than reflecting outdated conditions that may no longer be accurate. The update frequency may be determined by the rate at which environmental conditions change, with more frequent updates occurring when humans are moving rapidly through the environment or when the robot system 100 is navigating through a cluttered space, and less frequent updates occurring when the environment is relatively static.

Upon detection of a fault condition, the safety controller logic 800 transitions from the preemptive monitoring and determination phase to the active response phase, with fault condition detection 808 triggering parameter retrieval 810 that accesses the stored actuation parameters 806 and reaction wheel actuation 812 that executes the retrieved parameters to generate the biasing torque. The fault condition detection 808 monitors for various conditions that indicate the robot system 100 may fall or that continued operation poses a safety risk, with the fault condition comprising at least one of a power loss, an instability detection indicating that the robot system 100 has exceeded stability thresholds, or a human-proximity limit breach. Power loss detection may be performed by monitoring circuitry within the power system 700 that senses a drop in voltage or current from the primary power supply 702 below a threshold level, as described previously with reference to FIG. 7, and upon detecting such a drop, the fault condition detection 808 triggers the transition to the active response phase while the capacitor backup circuit 704 provides backup power to the safety controller 706 and the reaction wheel motor(s) 708. Instability detection may be performed by analyzing data from inertial measurement units or other sensors that measure the orientation and angular velocity of the robot system 100, with the fault condition detection 808 comparing the measured values against stability thresholds that define the boundaries of the robot's stable operating envelope; when the measured values exceed these thresholds, indicating that the robot system 100 is tilting or rotating at rates that exceed the ability of the normal balance control system to correct, the fault condition detection 808 triggers the transition to the active response phase. Human-proximity limit breach detection may be performed by analyzing data from the human detection system 202 to determine whether a human has entered a defined proximity zone during conditions where the robot system 100 cannot safely avoid contact, such as when the robot is moving at a speed that would not allow sufficient stopping distance or when the robot is already experiencing a balance disturbance; when such a breach is detected, the fault condition detection 808 may trigger a controlled fall in a direction away from the detected human rather than allowing an uncontrolled interaction that could result in greater harm.

The parameter retrieval 810 accesses the stored actuation parameters 806 upon detection of the fault condition by the fault condition detection 808, retrieving the precomputed actuation commands that correspond to the safe fall direction 308 as determined by the safe fall direction determination 804 based on the most recent environmental conditions. Because the stored actuation parameters 806 are continuously updated as environmental conditions change, the retrieved parameters reflect the safe fall direction 308 that was appropriate at the time of the most recent update, which in most cases will be within a short time interval prior to the fault condition detection and will therefore reflect conditions that are still current or nearly current at the time of the fault. The parameter retrieval 810 may be implemented as a memory read operation that accesses the stored actuation parameters 806 from a designated memory location, with the retrieval occurring rapidly to minimize the delay between fault condition detection 808 and reaction wheel actuation 812. In certain implementations, the stored actuation parameters 806 may be maintained in fast-access memory such as registers or cache memory to further reduce retrieval latency, ensuring that the actuation commands are available to the reaction wheel actuation 812 with minimal delay after the fault condition detection 808 triggers the active response phase.

The reaction wheel actuation 812 executes the retrieved actuation parameters by commanding the reaction wheel motor(s) 708 to accelerate or decelerate the at least one reaction wheel 106 according to the retrieved actuation commands, thereby generating the biasing torque that influences the fall trajectory of the robot system 100 toward the safe fall direction 308. The reaction wheel actuation 812 may implement the actuation commands as open-loop commands that are executed as specified in the stored actuation parameters 806, or the reaction wheel actuation 812 may implement closed-loop control that adjusts the actuation commands in real time based on sensor feedback regarding the robot's orientation and angular velocity during the fall. In closed-loop implementations, the reaction wheel actuation 812 may receive data from inertial measurement units or other sensors that remain powered during the fall-biasing response, using this data to track the robot's actual fall trajectory and to adjust the reaction wheel actuation to maintain effective torque generation in the direction of the safe fall direction 308 as the robot's orientation changes during the fall. The reaction wheel actuation 812 continues until the fall-biasing response is complete, which may be determined by detecting that the robot system 100 has reached a stable resting position, that the biasing torque has been applied for a predetermined duration, or that the capacitor backup circuit 704 has depleted its stored energy. Thus, the safety controller logic 800 provides a comprehensive framework for preemptively determining the safe fall direction 308 based on continuous environmental monitoring 802, storing actuation parameters 806 corresponding to the safe fall direction 308 for retrieval upon detecting the fault condition, updating the stored actuation parameters 806 as environmental conditions change, and executing the reaction wheel actuation 812 according to the retrieved actuation parameters to generate the biasing torque that influences the fall trajectory toward the safe fall direction 308.

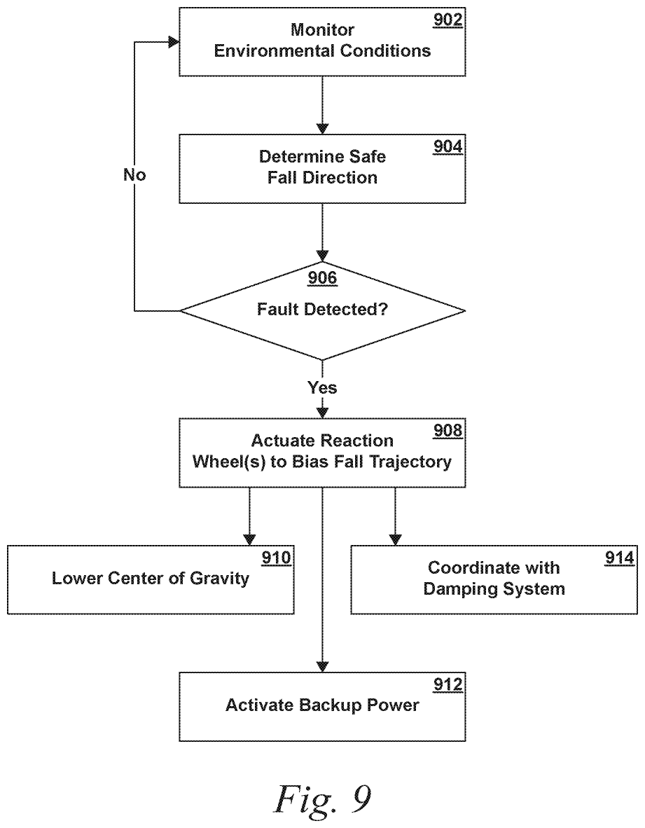

Referring to FIG. 9, a method for biasing a fall direction of a dynamically stable robot system during a safety event is illustrated as a flowchart comprising a series of operations that the safety controller 110 executes to detect fault conditions and actuate the at least one reaction wheel 106 to influence the fall trajectory toward the safe fall direction 308. The method begins with an operation 902 for monitoring environmental conditions using the sensor suite 108, which is configured to detect at least one of a presence of one or more humans, obstacles, or safe zones in the environment surrounding the robot system 100. The monitoring at operation 902 comprises identifying a presence and location of one or more humans in proximity to the robot system 100 using the human detection system 202, identifying objects and structural features using the obstacle sensors 204, and identifying designated safe zones within an environment using the mapping and localization system 206, as described previously with reference to FIG. 2. This continuous monitoring provides the environmental data that informs the subsequent determination of the safe fall direction 308, with the sensor suite 108 tracking changes in the positions of detected humans as the humans move through the environment, detecting new obstacles that enter the sensor field of view, and updating the robot's position within the mapped environment as the robot system 100 navigates from one location to another. The monitoring at operation 902 operates throughout normal operation of the robot system 100, maintaining an up-to-date understanding of the environmental conditions that would inform the selection of the safe fall direction 308 if a fault condition were to occur.

Following the monitoring at operation 902, the method proceeds to an operation 904 for determining the safe fall direction 308 based on the environmental conditions detected by the sensor suite 108. At operation 904, the safety controller 110 evaluates the relative positions of detected humans, obstacles, and safe zones with respect to the robot's current location and orientation, applying the prioritization criteria described previously with reference to FIG. 3 to select the safe fall direction 308 that maximizes safety outcomes by directing falls away from detected human(s) 302 and toward the designated safe zone 306 when such a zone is available within the reachable fall envelope. The determination at operation 904 may involve computing angular sectors around the robot system 100 that are occupied by humans or hazardous obstacles and identifying the angular sector or direction that provides the greatest safety margin when all factors are considered together, with secondary considerations including the positions of obstacles and structural features that may serve as beneficial fall targets or that should be avoided. The safety controller 110 calculates actuation commands for the at least one reaction wheel 106 based on the environmental conditions, determining the specific motor commands that would generate a biasing torque in the direction of the safe fall direction 308 when executed by the reaction wheel motor(s) 708, and stores these actuation parameters in the stored actuation parameters 806 for retrieval upon detecting a fault condition. The determination at operation 904 is performed preemptively during normal operation, with the stored actuation parameters 806 being continuously updated as environmental conditions change, such that when a fault condition is detected, the safety controller 110 can retrieve the precomputed actuation commands without requiring real-time computation of the safe fall direction 308 after the fault has already occurred.

The method proceeds to an operation 906 for detecting a fault condition that indicates the robot system 100 may fall or that continued operation poses a safety risk. At operation 906, the fault condition detection 808 monitors for various conditions including at least one of a power loss, an instability detection indicating that the robot system 100 has exceeded stability thresholds, or a human-proximity limit breach. Power loss detection may be performed by monitoring circuitry within the power system 700 that senses a drop in voltage or current from the primary power supply 702 below a threshold level, triggering the transition to the active response phase while the capacitor backup circuit 704 provides backup power to the safety controller 706 and the reaction wheel motor(s) 708. Instability detection may be performed by analyzing data from inertial measurement units or other sensors that measure the orientation and angular velocity of the robot system 100, with the fault condition detection 808 comparing the measured values against stability thresholds that define the boundaries of the robot's stable operating envelope and triggering the active response phase when the measured values exceed these thresholds. Human-proximity limit breach detection may be performed by analyzing data from the human detection system 202 to determine whether a human has entered a defined proximity zone during conditions where the robot system 100 cannot safely avoid contact, triggering a controlled fall in a direction away from the detected human rather than allowing an uncontrolled interaction that could result in greater harm.

Upon detecting the fault condition at operation 906, the method proceeds to an operation 908 for actuating the at least one reaction wheel 106 mounted within the torso 104 of the robot system 100 to generate a biasing torque that influences a fall trajectory of the robot system 100 toward the safe fall direction 308. At operation 908, the parameter retrieval 810 accesses the stored actuation parameters 806 to retrieve the precomputed actuation commands corresponding to the safe fall direction 308, and the reaction wheel actuation 812 executes the retrieved parameters by commanding the reaction wheel motor(s) 708 to accelerate or decelerate the at least one reaction wheel 106 according to the retrieved actuation commands. The biasing torque is generated by the at least one reaction wheel 106 spinning within the enclosed housing 112 of the torso 104 such that the at least one reaction wheel 106 is not accessible from outside the housing 112 during the fall-biasing response, thereby containing the torque-generating mechanism within the robot system 100 and preventing external contact with the spinning reaction wheel during the safety event. For embodiments employing the fixed-axis multi-wheel configuration described with reference to FIG. 6, actuating the at least one reaction wheel comprises actuating the first reaction wheel 602 and the second reaction wheel 604 in coordinated fashion to generate the net torque vector 606 in the safe fall direction 308 by combining outputs from the two reaction wheels in varying proportions, with the relative magnitudes of the actuation commands for each reaction wheel determined by the geometric relationship between the reaction wheel axes and the desired torque direction. For embodiments employing the reorientable single-wheel configuration described with reference to FIG. 5, actuating the at least one reaction wheel comprises orienting a rotational axis of the reaction wheel 502 perpendicular to the safe fall direction 308 by commanding the orientation actuator 506, and then actuating the reaction wheel 502 via the rotation motor 504 to generate the biasing torque in the torque direction 508.

The method may further comprise an operation 910 for lowering a center of gravity of the robot system 100 upon detecting the fault condition, which reduces the potential energy of the system and decreases the severity of impact forces that may result from a fall. For embodiments where the robot system 100 comprises a wheeled mobile base including two coaxially arranged drive wheels, the method at operation 910 can include retracting a telescoping leg connecting the wheeled mobile base to the torso 104 upon detecting the fault condition to lower the center of gravity of the robot system 100, with the telescoping joint including an upper part and a lower part that slide relative to each other along a telescoping axis to bring the torso 104 closer to the locomotion base 102. For embodiments where the robot system comprises the legged robot system 400 with the legged base 406 including the first leg 408 and the second leg 412 configured to support and locomote the robot system, the method at operation 910 may include actuating the joint 410 of the first leg 408 and the joint 414 of the second leg 412 to lower the center of gravity of the legged robot system 400 upon detecting the fault condition, with the joints 410, 414 flexing in a manner that brings the torso 402 closer to the ground surface. The legs are collapsed to reduce the height and center of gravity of the robot to reduce the restoring torque required, facilitating the fall-biasing response by reducing the moment arm between the center of gravity and the ground contact points. This coordination between the joint actuation or leg retraction that lowers the center of gravity and the reaction wheel actuation that generates the biasing torque enables the robot system to achieve more effective fall direction control than would be possible with either mechanism alone.

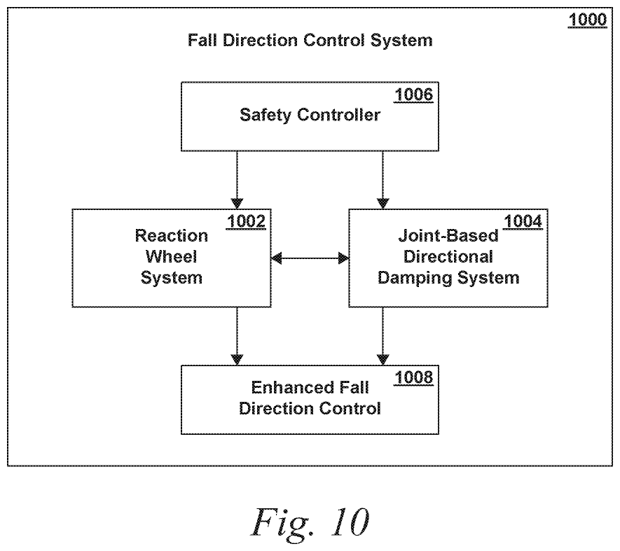

The method may further comprise an operation 912 for activating the capacitor backup circuit 704 to provide backup power for actuating the at least one reaction wheel 106 when the fault condition comprises detecting a power loss from the primary power supply 702. At operation 912, the capacitor backup circuit 704 transitions to providing backup power to the safety controller 706 and the reaction wheel motor(s) 708, enabling the fall-biasing safety function to execute even when the primary power systems are compromised. The capacitor backup circuit 704 stores sufficient energy to power actuation of the at least one reaction wheel 106 for the duration of the fall-biasing response, ensuring that the safety function can complete its operation from the moment of fault detection through the generation of the biasing torque that influences the fall trajectory toward the safe fall direction 308. This backup power capability addresses the scenario where power loss itself is the fault condition that triggers the safety response, ensuring that the robot system 100 can execute a controlled fall toward a safer direction rather than falling in an uncontrolled manner. Additionally, the method may further comprise an operation 914 for coordinating actuation of the at least one reaction wheel 106 with a joint-based directional damping system to provide enhanced fall direction control, as described subsequently with reference to FIG. 10, where the active torque generation from reaction wheels complements the passive resistance provided by joint damping to enable more precise and reliable fall trajectory management across a wider range of fault scenarios.

During normal operation of a dynamically stable wheeled robot, the method further comprises maintaining balance using the at least one reaction wheel 106 and generating the biasing torque using the at least one reaction wheel 106 during the safety event. Thus, the reaction wheels may serve multiple functions that include balance maintenance, disturbance rejection, and counteracting destabilizing forces during movement in addition to the fall direction biasing function activated during safety events. The method further comprises counteracting destabilizing forces during movement of the robot system 100 using the at least one reaction wheel 106, including counteracting forces encountered when rounding corners or traversing uneven terrain. A sagittal reaction wheel provides a pitching action to lean the body forward when the robot is moving forward, enabling the robot system 100 to maintain balance during forward locomotion by generating torque that counteracts the tendency of the robot to pitch backward as the drive wheels accelerate. A frontal reaction wheel provides the centripetal force required to stabilize the robot during turning, allowing the robot to lean far enough to the side to take a turn on a single wheel in aggressive maneuvers, with the frontal reaction wheel generating torque that counteracts the lateral forces acting on the robot's body during the turn. When traversing uneven terrain such as carpets, thresholds, or transitions between flooring types, the reaction wheels can respond to momentary disturbances faster than the drive wheels can reposition, smoothing the robot's motion and preventing the disturbances from propagating into larger instabilities. Thus, for dynamically stable wheeled robots, the reaction wheels that are used for balance maintenance and movement stabilization during normal operation may be the same reaction wheels that generate the biasing torque during safety events, providing an integrated approach that leverages existing hardware for the safety function.

Referring to FIG. 10, a fall direction control system 1000 comprises a reaction wheel system 1002, a joint-based directional damping system 1004, and a safety controller 1006 that coordinates the reaction wheel system 1002 and the joint-based directional damping system 1004 to achieve enhanced fall direction control 1008. The fall direction control system 1000 represents a configuration where two distinct mechanisms for influencing fall trajectory are combined under unified control to provide more precise and reliable fall trajectory management than either mechanism could achieve independently. The reaction wheel system 1002 encompasses the at least one reaction wheel 106 mounted within the torso 104 as described previously with reference to FIG. 1, including the reaction wheel motor(s) 708 that drive the reaction wheels and the associated control electronics that receive commands from the safety controller 1006. The joint-based directional damping system 1004 comprises damping mechanisms associated with one or more joints of the robot system 100, where these damping mechanisms apply differential resistance to joint motion to bias the direction of a fall by making movement in some directions more difficult than movement in other directions. The safety controller 1006 receives data from the sensor suite 108 regarding environmental conditions, determines the safe fall direction 308 based on the positions of detected humans, obstacles, and safe zones as described previously with reference to FIG. 3, and coordinates the operation of both the reaction wheel system 1002 and the joint-based directional damping system 1004 to influence the fall trajectory toward the safe fall direction 308 when a fault condition is detected.

The coordination between the reaction wheel system 1002 and the joint-based directional damping system 1004 leverages the complementary characteristics of active torque generation and passive resistance to achieve the enhanced fall direction control 1008. The reaction wheel system 1002 provides active torque generation capability, meaning that the reaction wheels can generate torque to push the robot system 100 in a desired direction rather than merely resisting motion in undesired directions. This active torque generation enables more forceful and rapid influence over the fall trajectory, which may be particularly valuable when the robot system 100 has substantial momentum in an undesired direction or when a specific fall direction is needed for safety. In contrast, the joint-based directional damping system 1004 provides passive resistance that opposes motion in certain directions more strongly than in other directions, thereby influencing the fall trajectory by making it more difficult for the robot system 100 to fall in directions where greater damping is applied. The passive nature of joint-based damping means that the joint-based directional damping system 1004 does not actively push the robot system 100 toward the safe fall direction 308 but rather resists motion away from that direction, slowing or partially redirecting the fall trajectory through differential resistance. By combining the active torque generation of the reaction wheel system 1002 with the passive resistance of the joint-based directional damping system 1004, the fall direction control system 1000 can both push the robot system 100 toward the safe fall direction 308 and resist motion away from that direction, providing a more comprehensive approach to fall trajectory management than either mechanism alone.

The safety controller 1006 is configured to coordinate actuation of the at least one reaction wheel 106 with the joint-based directional damping system 1004 to provide the enhanced fall direction control 1008, with this coordination involving the determination of appropriate commands for both systems based on the safe fall direction 308 and the current state of the robot system 100. When the safety controller 1006 detects a fault condition, the safety controller 1006 retrieves the stored actuation parameters 806 corresponding to the safe fall direction 308 and generates commands for both the reaction wheel system 1002 and the joint-based directional damping system 1004 that work together to influence the fall trajectory toward the safe fall direction 308. The commands for the reaction wheel system 1002 specify the actuation of the reaction wheel motor(s) 708 to generate biasing torque in the direction of the safe fall direction 308, as described previously with reference to FIG. 8 and FIG. 9. The commands for the joint-based directional damping system 1004 specify the damping characteristics to be applied at each joint, with greater damping applied to resist motion in directions away from the safe fall direction 308 and lesser damping applied to permit motion toward the safe fall direction 308. The safety controller 1006 may adjust the relative contributions of the reaction wheel system 1002 and the joint-based directional damping system 1004 based on factors such as the magnitude and direction of the robot's momentum at the time of fault detection, the distance to the safe fall direction 308 from the robot's current trajectory, and the available torque capacity of the reaction wheels given their current rotational state.

The enhanced fall direction control 1008 achieved through the coordination of the reaction wheel system 1002 and the joint-based directional damping system 1004 provides several benefits compared to systems that employ either mechanism alone. The active torque from the reaction wheel system 1002 can counteract momentum in undesired directions more effectively than passive damping alone, enabling the fall direction control system 1000 to redirect falls even when the robot system 100 is moving with substantial velocity in a direction away from the safe fall direction 308. Moreover, the passive resistance from the joint-based directional damping system 1004 continues to influence the fall trajectory even if the reaction wheels reach their torque limits or if the reaction wheel system 1002 experiences a malfunction, providing redundancy in the fall direction control capability. The combination of active and passive mechanisms also enables more precise control over the fall trajectory, as the safety controller 1006 can use the reaction wheel system 1002 to generate the primary biasing torque while using the joint-based directional damping system 1004 to fine-tune the trajectory by selectively resisting deviations from the desired path. Furthermore, the coordinated approach may reduce the torque demands on the reaction wheel system 1002 by having the joint-based directional damping system 1004 absorb some of the energy associated with motion in undesired directions, allowing the reaction wheels to focus their torque generation capacity on actively pushing the robot system 100 toward the safe fall direction 308 rather than on counteracting all of the robot's momentum.

The fall direction control system 1000 shown in FIG. 10 represents a configuration where the safety controller 1006 serves as the central coordinator that receives environmental data, determines the safe fall direction 308, and generates commands for both the reaction wheel system 1002 and the joint-based directional damping system 1004 to achieve the enhanced fall direction control 1008. The safety controller 1006 may be the same safety controller 110 described previously with reference to FIG. 1, with the safety controller 110 having the additional capability to coordinate with the joint-based directional damping system 1004 in addition to actuating the at least one reaction wheel 106. The coordination performed by the safety controller 1006 may involve simultaneous actuation of both systems upon detection of a fault condition, sequential actuation where one system is activated before the other based on the timing requirements of the particular fault scenario, or adaptive actuation where the relative contributions of the two systems are adjusted in real time based on sensor feedback regarding the robot's fall trajectory. The enhanced fall direction control 1008 resulting from this coordination enables more precise and reliable fall trajectory management across a wider range of fault scenarios than would be achievable with the reaction wheel system 1002 or the joint-based directional damping system 1004 operating independently, providing the robot system 100 with a comprehensive fall direction control capability that leverages both active torque generation and passive resistance to influence the fall trajectory toward the safe fall direction 308.

This disclosure is not intended to be exhaustive or to limit the present technology to the precise forms disclosed herein. Although specific embodiments are disclosed herein for illustrative purposes, various modifications are possible without deviating from the present technology, as those of ordinary skill in the relevant art will recognize. In some cases, well-known structures and functions have not been shown or described in detail to avoid unnecessarily obscuring the description of the embodiments. Although steps of methods may be presented herein in a particular order, in alternative embodiments the steps may have another suitable order. Similarly, some aspects of the present technology disclosed in the context of particular embodiments can be combined or eliminated in other embodiments. Furthermore, while advantages associated with some embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein. To the extent that any statement herein regarding expected operation or anticipated behavior is found to be inaccurate or incomplete, such inaccuracy or incompleteness should not be construed as limiting the scope of the claims or as an admission that the disclosed technology does not function as claimed. The claims define the scope of protection sought and should be interpreted based on their language rather than on any particular performance expectations described in this specification.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. Furthermore, use of the term “at least” is merely for emphasis—it does not indicate that statements without this term should be interpreted as closed ended. References herein to any of “receiving,” “determining,” or “generating” information in accordance with various embodiments of the present technology encompass, when feasible, the others of “receiving,” “determining,” and “generating” the information and indicate that such operations can occur at least partially via the relevant computing subsystem. As used herein, the terms “based on,” “by,” “via,” and the like do not imply exclusivity unless the context clearly indicates otherwise. Thus, “based on” means based at least partially on, “by” means at least partially by, and “via” means at least partially via.

Directional terms, such as “upper,” “lower,” “front,” “back,” “vertical,” “horizontal,” “anterior,” “posterior,” “dorsal,” “lateral,” “superior,” and “inferior,” may be used herein to express and clarify the relationship between various structures. It should be understood that such terms do not denote absolute orientation but rather describe relative positioning. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Also, different combinations of features from various embodiments may be implemented together. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in some respects and different in other respects. The term “real-time” as used herein should be understood to encompass not only instantaneous processing but also processing with some delay that is sufficiently responsive for the particular operational context, and may include near-real-time processing with acceptable latency for the specific application requirements. Finally, it should be noted that various particular features, structures, and operations of the embodiments described herein may be combined in any suitable manner in additional embodiments in accordance with the present technology.

1. A robot system, comprising:
a locomotion base configured to support the robot system;
a torso carried by the locomotion base;
at least one reaction wheel mounted within the torso;
a sensor suite configured to detect environmental conditions including at least one of a presence of one or more humans, obstacles, or safe zones; and
a safety controller configured to:
monitor the environmental conditions detected by the sensor suite, determine a safe fall direction based on the environmental conditions, detect a fault condition, and
upon detecting the fault condition, actuate the at least one reaction wheel to generate a biasing torque that influences a fall trajectory of the robot system toward the safe fall direction.

2. The robot system of claim 1, wherein the locomotion base comprises a wheeled mobile base including two drive wheels.

3. The robot system of claim 2, wherein the two drive wheels are coaxially arranged.

4. The robot system of claim 2, further comprising a leg connecting the wheeled mobile base to the torso.

5. The robot system of claim 4, wherein the leg comprises a telescoping joint configured to adjust a height of the torso relative to the wheeled mobile base.

6. The robot system of claim 5, wherein the safety controller is configured to retract the telescoping joint upon detecting the fault condition to lower a center of gravity of the robot system.

7. The robot system of claim 1, wherein the locomotion base comprises a legged base including at least two legs configured to support and locomote the robot system.

8. The robot system of claim 7, wherein the legged base comprises a bipedal humanoid configuration.

9. The robot system of claim 7, wherein at least one of the at least two legs comprises a joint configured to adjust a height of the torso relative to a ground surface.

10. The robot system of claim 9, wherein the safety controller is configured to actuate the joint to lower a center of gravity of the robot system upon detecting the fault condition.

11. The robot system of claim 1, wherein the at least one reaction wheel comprises two reaction wheels positioned at an angle to each other within the torso.

12. The robot system of claim 11, wherein the safety controller is configured to actuate the two reaction wheels in coordinated fashion to generate a net torque vector in the safe fall direction by combining outputs from the two reaction wheels in varying proportions.

13. The robot system of claim 1, wherein the at least one reaction wheel comprises a single reaction wheel mounted on an actuated joint that allows a rotational axis of the single reaction wheel to be dynamically reoriented.

14. The robot system of claim 13, wherein the safety controller is configured to:
command the actuated joint to orient the rotational axis of the single reaction wheel perpendicular to the safe fall direction; and
actuate the single reaction wheel to generate the biasing torque.

15. The robot system of claim 1, wherein the safety controller is further configured to:
preemptively determine the safe fall direction based on continuous environmental monitoring; and
store actuation parameters corresponding to the safe fall direction for retrieval upon detecting the fault condition.

16. The robot system of claim 15, wherein the safety controller is configured to update the stored actuation parameters as the environmental conditions change.

17-19. (canceled)

20. The robot system of claim 1, further comprising a joint-based directional damping system, wherein the safety controller is configured to coordinate actuation of the at least one reaction wheel with the joint-based directional damping system to provide enhanced fall direction control.

21. The robot system of claim 1, wherein the sensor suite comprises:
a human detection system configured to identify a presence and location of one or more humans in proximity to the robot system;
obstacle sensors configured to identify objects and structural features; and
a mapping and localization system configured to identify designated safe zones within an environment.

22. The robot system of claim 21, wherein the safety controller is configured to determine the safe fall direction by prioritizing:
directing falls away from detected humans; and
directing falls toward the designated safe zones.

23. The robot system of claim 1, wherein the torso comprises a housing that encloses the at least one reaction wheel such that the at least one reaction wheel is not accessible from outside the housing.

24-47. (canceled)
